(19) United States
(12) Patent Application Publication
(10) Pub. No.: US 2008/0047017 A1
(43) Pub. Date: Feb. 21, 2008

(54) SYSTEM AND METHOD FOR DYNAMICALLY ASSESSING SECURITY RISKS ATTRIBUTED TO A COMPUTER USER'S BEHAVIOR

(76) Inventor: Martin Renaud, Maple Ridge (CA)

Correspondence Address: PERKINS COIE LLP;PATENT-SEA, P.O. BOX 1247, SEATTLE, WA, 98111-1247, US

(21) Appl. No.: 11/768,147

(22) Filed: Jun. 25, 2007

Related U.S. Application Data
(60) Provisional application No. 60/816,216, filed on Jun. 23, 2006.

(51) Int. Cl. G06F 17/00; G06Q 30/00

(52) U.S. Cl. 726/25; 705/14

(57) ABSTRACT

Methods and systems are described for assessing computer security risks attributed to a computer user's behavior. In accordance with these methods and systems, a user is presented on a computer with a series of questions concerning behaviors that may affect a risk or benefit to the user's security. The computer receives input on the computer from the user responding to the questions. As responses are received to the questions, the computer dynamically assesses changes to the user's security level as a result of additional information provided by the response. The computer then displays a visual indication of the user's security level.

### CROSS REFERENCE TO RELATED APPLICATION(S)

This application claims priority to U.S. Provisional Patent Application No. 60/816,216, filed 23 Jun. 2006, entitled “System and method for dynamically assessing security risks attributed to a computer user's behavior,” (attorney docket no. 60783.8005).

### BACKGROUND

Over the past several years, the Internet has evolved to provide what would seem to be limitless opportunities for online commerce and communications. Most computer users have purchased at least some goods from an online retailer, subscribed to an online newspaper or periodical, or performed some personal banking or stock trading online. Users who become proficient with these activities gravitate toward “subscribing” to more and more websites, each of which typically requiring a password and “registration” of personal information before providing access. By registering with various websites, a user can enjoy activities such as downloading music or videos, receiving news programs tailored to particular interests, purchasing books or other goods, and partaking in myriad other media that is available over the web.

While the vast majority of experiences with online commerce are safe, users unfortunately are becoming increasingly susceptible to viruses and instances of fraud or theft. Passwords can be deciphered, misappropriated (when written down), or sometimes, simply guessed. Viruses can lurk within emails. A “hacker” can erase data from a user's machine, illegally access personal or financial information that a user provided online, or even steal a user's identity to create phony credit card accounts, money loans and online purchases. These dangers are also of grave concern to employers, who stand to have networks containing highly confidential business information infiltrated via a computer of an unsuspecting employee.

There are many ways in which a computer user's routine practices affect the likelihood of downloading computer viruses or suffering theft of electronic information. Being generally aware about the dangers of internet commerce and being diligent to avoid unnecessary risks are often considered to be the greatest deterrents to Internet crime. As an example, most users know to avoid providing financial account information in response to emailed requests to significantly reduce the risk of falling victim to costly computer scams. On the other hand, electronic virus outbreaks continually occur because unsuspecting users open email attachments laced with a virus in an unsolicited email from an unrecognized sender. Although many users are aware of at least some recommended protocols for enhancing their security when operating a computer, most routinely take risks without appreciating the likelihood and severity of an intrusion or the ease by which such risks can be avoided.

In our society, computer users are bombarded with advertisements to access different websites to receive desired information or goods in return for providing personal information. While most users are generally aware about the existence of viruses and other dangers of engaging in electronic commerce recommendations, few profess to have a strong understanding of what security-related behaviors offer the greatest protection without unduly compromising the opportunities to engage in beneficial online commerce. As a result, many users are at the extremes of being either overly cautious or otherwise oblivious concerning their security online.

Experts in the industry have repeatedly stated that one of the solutions to these ongoing problems is enhanced computer education. Unfortunately, even industry professionals admit to not adhering to their own advice. Passwords get shared, and reused on multiple sites, tokens get misplaced or forgotten in public places and the desire to complete a task often takes precedence over caution, even by those with the most education about these issues.

There is a need for new methods of educating all computer users about the many facets of online security. These methods must make the information salient when it is needed most, and be persuasive to compel users to heed caution when appropriate to, and to feel empowered to reap all of the many benefits that technology can provide without undue fear.

### BRIEF DESCRIPTION OF THE DRAWINGS

FIG. 1 is a block diagram illustrating a suitable system in which various embodiments may operate on a computer or workstation with associated peripherals.

FIG. 2 is a block diagram illustrating a suitable system in which various embodiments may operate in a networked computer environment.

FIG. 3 illustrates a series of databases that may be employed in an exemplary system in accordance with various embodiments.

FIG. 4 is a flow diagram for an exemplary embodiment.

FIG. 5 is a flow diagram for a second exemplary embodiment.

FIG. 6 is an exemplary computer screen display according to an exemplary embodiment.

### DETAILED DESCRIPTION

Described in detail below is an education tool for users, such as for security product consumers. This tool, which may be provided via a web site, presents users with a series of questions about their own security behavior and awareness. As they select responses to those questions, users are given feedback regarding how those selections affect security, such as the security of personal and financial information on the internet. This tool can address one of the security problems in the world: lack of awareness of security threats and their associated risks.

An additional component of this tool is that it allows a user to modify the user's responses to receive feedback on how changes in behavior affect changes in security. The feedback on security behavior shows the user what the proper course of action should be for a variety of specific, security related digital contexts.

A third component allows for groups of users to make suggestions on the amount of risk that should be associated with specific security behaviors. The suggestions create a unique measure of risk based on global risk perception. This separate measure will be compared to the quantified feedback measures to show discrepancy between the beliefs about security and the reality of security.

Various embodiments will now be described. The following description provides specific details for a thorough understanding and enabling description of these embodiments. One skilled in the art will understand, however, that the system and method described herein may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

### I. Representative Computing Environment

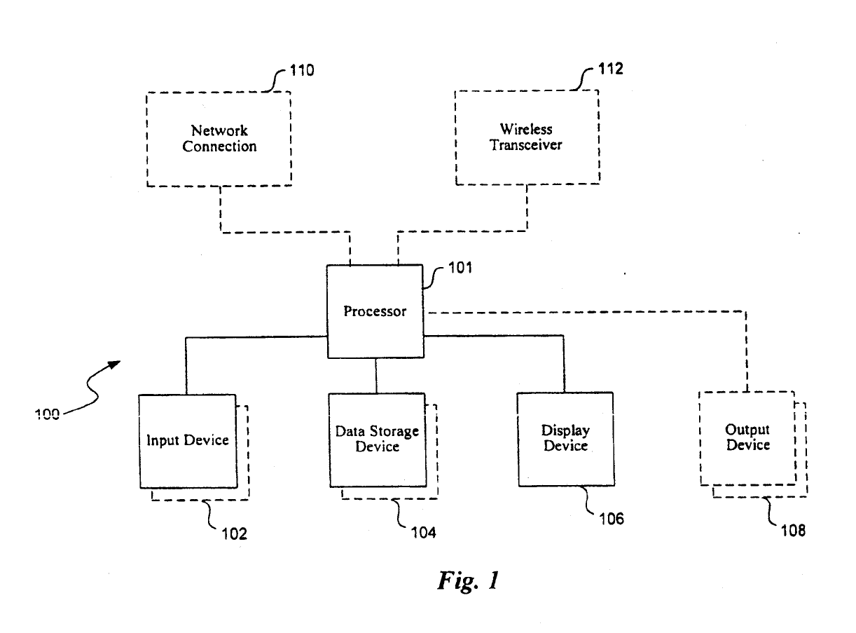

FIG. 1 and the following discussion provide a brief, general description of suitable computing environments in which various embodiments can be implemented. Although not required, aspects and embodiments will be described in the general context of computer-executable instructions, such as routines executed by a general-purpose computer, e.g., a server or personal computer. Those skilled in the relevant art will appreciate that these embodiments can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The embodiments can be implemented in a special purpose computer or data processor that is specifically programmed, configured or constructed to perform one or more of the computer-executable instructions explained in detail below. Indeed, the term “computer”, as used generally herein, refers to any of the above devices, as well as any data processor.

The embodiments also can be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions may reside on a server computer, while corresponding portions reside on a client computer. Data structures and transmission of data particular to aspects of the system are also encompassed within the scope of the disclosure.

Referring to FIG. 1, one embodiment employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 1).

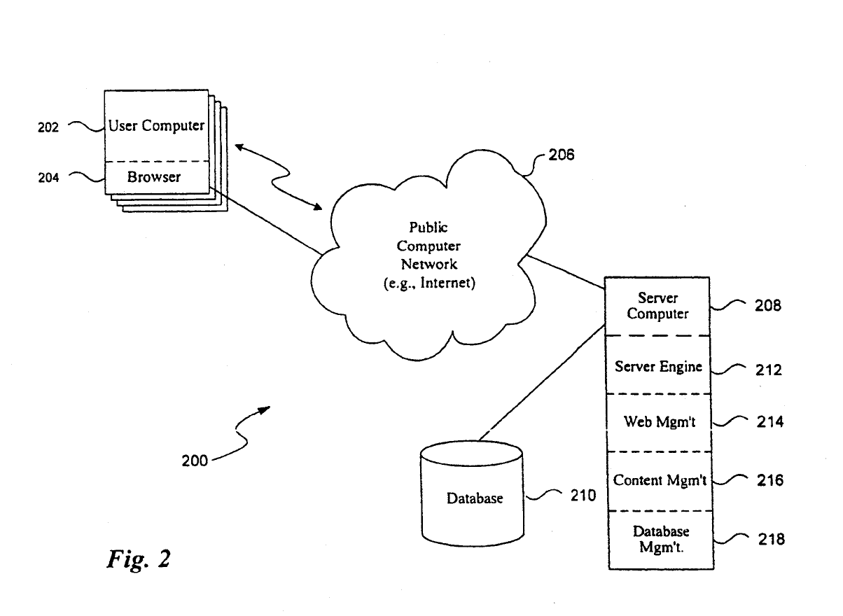

Aspects may be practiced in a variety of other computing environments. For example, referring to FIG. 2, a distributed computing environment with a web interface includes one or more user computers 202 in a system 200 are shown, each of which includes a browser program module 204 that permits the computer to access and exchange data with the Internet 206, including web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data such as video, graphics and audio signals.

Aspects of the system may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the system are equally applicable to nodes on a network.

### II. Suitable Implementation and Overview

In accordance with certain aspects of the system, a tool, sometimes referred to “EMPOWER”, is provided that presents sequences of questions pertaining to a user's security-related behavior. Based upon the user's responses, the tool dynamically generates outcomes, such as a confidence rating or threat level indicator, to inform the user as to risks or benefits associated with the user's particular behaviors. The tool can operate on an anonymous basis to encourage frank responses, or it may be configured for use with identified individuals or subscribers. In some embodiments, the tool can be used for marketing or educational purposes.

To assess a computer user's security risk level, the tool presents one or more questions concerning topics such as authentication (using passwords, usernames, tokens, etc.), online infrastructure (firewalls, virus protection installations, etc.), and user behavior (habits, routines, or practices that can affect the security of a computer system). The questions can be presented to a user via a networked computer accessing a webpage, a standalone computer accessing a program stored locally, or via any other computer system. To respond to the questions, a user can select from one or more possible answers to each question, or provide a free-form answer in a text field.

Some of the questions may relate to issues commonly associated with computer security, such as password sharing, token misplacement, email attachment protocols and frequency of calling a helpdesk for resets. Other questions may relate to behaviors less commonly recognized as affecting a user's computer security, such as leaving a purse or wallet unattended, casually discarding receipts, using a same password for both work and for personal banking, frequently accessing Internet websites that require passwords (thereby increasing the propensity to overuse a small set of low-complexity passwords), etc. Responses can be registered by, for example, having the user mouse click on the answer that most closely matches their response to a given question.

In one embodiment, the questions are generated dynamically based upon the responses received. As a basic example, if a user indicates that he does not use a token, then it is unnecessary to ask follow-up questions concerning whether he leaves the token unattended within the vicinity of his desktop. As described below in further detail, the system stores a bank of possible questions in a database, and a question generator determines dynamically which questions to retrieve from the database based upon a user's ongoing responses.

As an additional embodiment, to maintain the user's interest, the system can be configured to provide useful feedback after each selection to explain the security-related consequences of the user's behavior. As described in further detail below, the system can display a “security meter” or some other type of scale that is updated after each response. As a further embodiment or in the alternative, the system can provide a description that explains how the particular behavior in question affects the user's security risks. The system can additionally or instead provide this information visually through either still or moving images.

Thus, additional educational material can be made available regarding each response selection. In an additional embodiment, adjacent to each question is a selection button that directs the users to a separate page that provides specific educational information about the security risks associated with changes in responses to this question. At any appropriate time, the user can be provided with secondary references so as to seek additional information to obtain additional clarification on the issues.

Additionally, users can be shown a graph, or similar representation of all responses given by other users on the system to the same question, or group of questions. This graph could contain a temporal dimension to show if users are becoming more or less security aware over days, months, or any other scale of duration. This form of “social network” comparison between a user and his peers allows the user to aim for doing better than others.

Returning to FIG. 1, a user who is operating computer system 100 can receive questions via network connection 110, which are then sent to display device 106. The user then responds using input device 102, which triggers the processor 101 to send information to the network connection 110. As shown in FIG. 2, the questions can be provided to User Computer 202 via a browser 204 that connects to the Internet 206. The questions are stored in database 210, managed by database manager 218 and content manager 216, which acts as a question generator controlled by server computer 208. In another embodiment, the questions are stored in Data Storage Device 104, residing locally within computer 100.

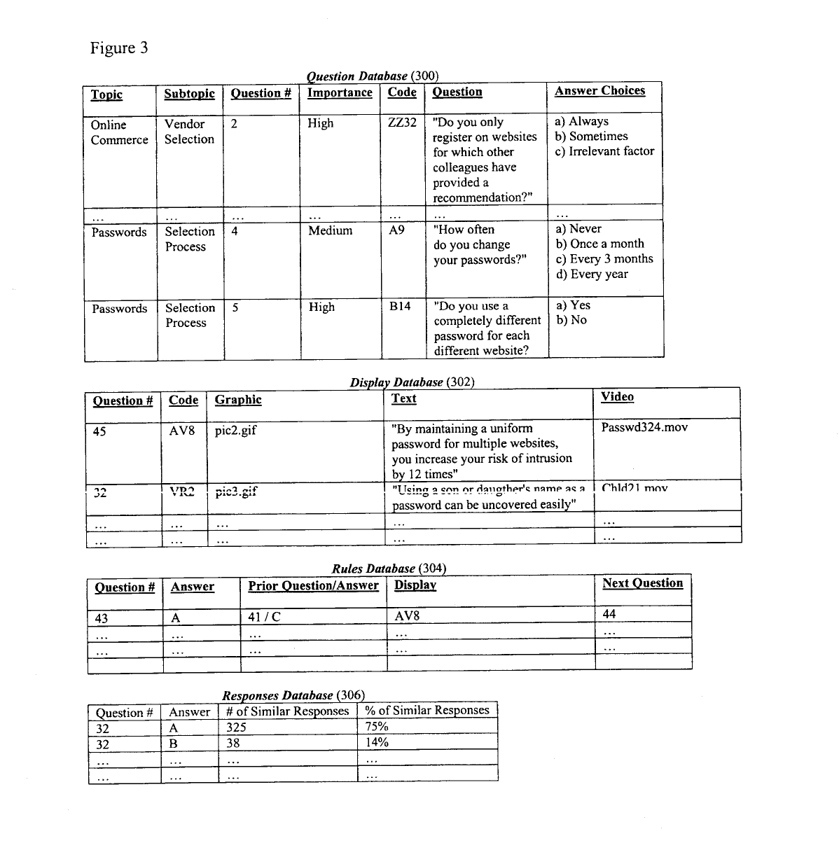

The database 210 in FIG. 2 may represent a series of databases, such as a Question database 300, Display database 302, Rules database 304, and Responses database 306, as shown in FIG. 3. As described above, the Question database 300 stores at least one possible question to ask. The server computer may be an open system where additional questions easily can be added to the list as new security-related issues arise.

The Question database 300 may store information in the format of a table. As shown in FIG. 3, Question database includes fields for “Topic,” “Subtopic,” “Question #,” “Importance,” “Code,” “Question,” and “Answer Choices.” One example of a question provided in the table is “How often do you change your password?”, with four answer choices offered. Of course, many different fields can be substituted for these, or added, without departing from the scope of the disclosure. Of course, other configurations are possible.

The Display database 302 contains descriptions or graphics that may be provided to User Computer 202 as answers are received. In FIG. 3, Display database includes fields for “Question,” “Code,” “Graphic, “Text,” and “Video.” Depending upon the Rules database, described below, a processor determines whether to provide a graphic image, some text, or a video that is associated with the instant question/answer exchange.

A Rules database 304 can be used to determine which questions should be presented from the questions database and in what order, and how responses should change a “security meter” or some other indicator of a user's security risks. In some embodiments, this database may be configured for easy modification and reorganization to stay timely. For example, if it becomes known that computers are especially susceptible to viruses when a certain behavior is undertaken, questions relating to this behavior will become more significant. In the exemplary embodiment, fields for the Rules database include “Question,” “Answer,” “Prior Question/Answer,” “Display,” and “Next Question.”

Finally, a Responses database 306 may store responses from users to enable the server computer 208 to prepare some tabulated format to assess overall security for an organization or some other large sample.

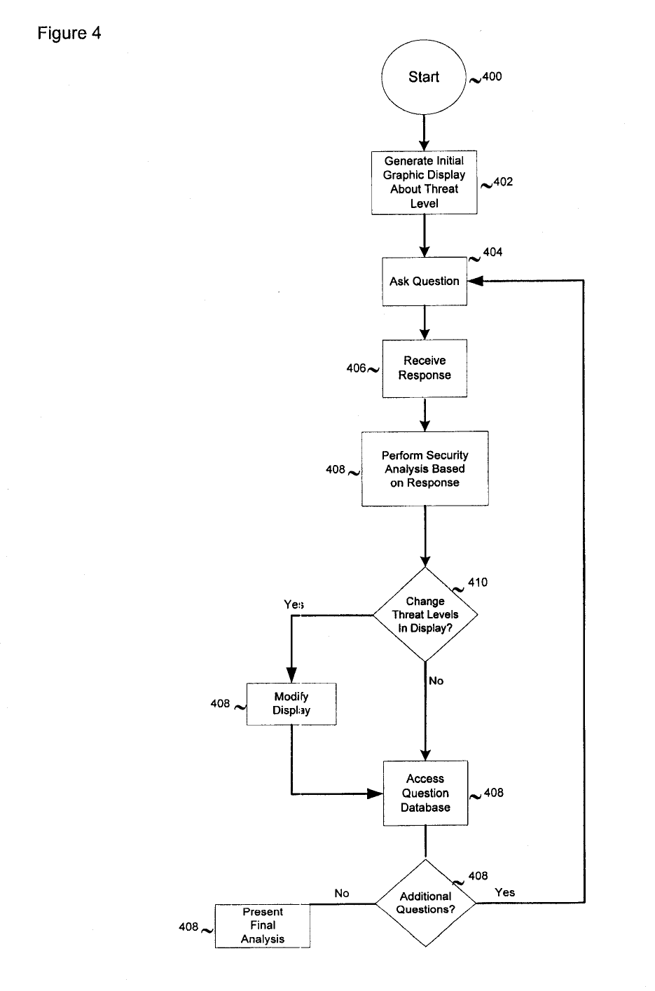

FIG. 4 is a flow diagram illustrating steps for performing an exemplary method of evaluating a user's security risk. After starting in step 400, the system generates an initial graphic display about a user's security level, in step 402. In step 404, a question is asked, and a response is received in step 406. Based on the user's response, a security analysis is performed in step 408. Referring to FIG. 3, this security analysis may occur based upon entries in the Rules database. Returning to the method, a determination is made in step 408 whether to change the user's threat level in a display based upon the previous response. If a change is to be made, the display is modified accordingly in step 412. The question database is then accessed in step 414, and a determination is made in step 416 as to whether additional questions are to be asked. The method returns to step 404 until no more questions remain, at which time a final risk analysis is performed and presented in step 418.

In this example, users do not have to provide a login name or password to access the system. In some settings, an anonymous system is preferred to reduce the chance that some users may not be honest in their responses. With an anonymous system, users can be encouraged to experiment with the checkboxes, and advised to try to check and uncheck various responses to each question so they can learn what the effect of a variety of behaviors each has on security. For example, users could try out various numbers of characters in a password to reveal how increases in password length affect the overall security of a user's information.

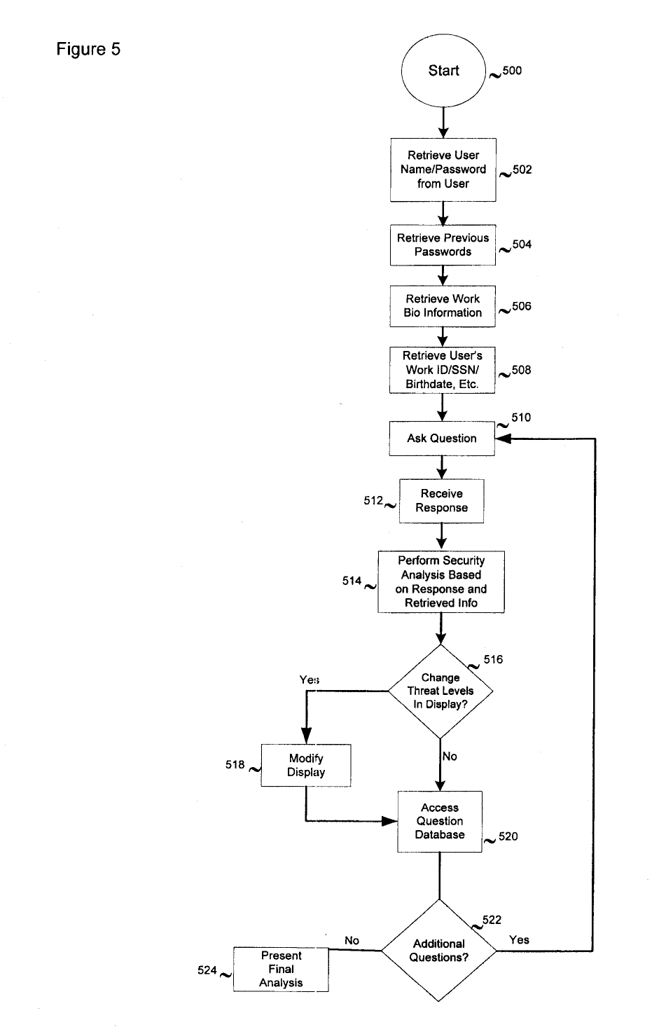

FIG. 5 is a flow diagram of an exemplary method for assessing a user's security risk utilizing a system that can identify the user and retrieve information about the user's profile and behavior. In this example, after starting in step 500, the system automatically retrieves the user's name and password that is either registered within the computer itself or on the network in step 502. Assuming that the information is stored, in step 504 the system retrieves, as non-limiting examples, previous passwords, as well as work biographical information, and the social security number, birthdate, etc., in steps 506 and 508. As in the method described with reference to FIG. 4, the system then proceeds to ask a question in step 510, and receive a response in step 512. At this stage, the security analysis is performed during step 514 based both on the user's response and the retrieved data. Based on this response, a determination is made in step 516 whether to change the threat level, and if so, the display is modified in step 518. The question database is then accessed in step 520 to determine whether additional questions remain. If not, a final analysis is presented to the user in step 524.

In connection with the Rules database described with reference to FIG. 3, the system can use a series of weighted decision algorithms to quantify the risk effects and synergistic effects of the responses that are checked off. The end result can be two numbers, one number quantifies the estimated risk of loss of information and the other quantifies the benefit for the user as a percentage deviation from perfect behavior, or any other indicia of risk. Each value then can be presented to the user on a separate visual scale (utilizing the Display database). The first value can be shown as a value on a scale of potential penetration by a non-user. This scale changes with each response selection to show the user's potential for loss. The second value can be shown on a scale of perfect or desired behavior. Accordingly, the user is able to determine what the best possible combination of behaviors is by monitoring this meter and examining how close their behavior is to maximizing or improving security. At any time, users can change the boxes that are checked and observe the effects of these behavioral changes on their security. Each change to their behavior can be shown to have an effect on their security.

The decision weighting equations may be similar to common expected utility models like D. Kahneman's Prospect theory. The “prospect” is the outcome of a set of weighted decisions. The algorithm is plotted as a non-monotonic curve with the inflection point over the origin of the plot. The positive portion of the curve provides the estimate of the benefit to the user of each decision. The negative portion of the curve provides the estimate of the risk of loss. Each response has a separate weighting for gains and losses that factor into the final outcome. The weighted decision outcomes are recalculated with each change in response pattern. This system allows for an exponential curve that relates closely to economic and behavioral utility patterns found in research over the past 40 years.

The systems and methods described above have a number of advantages over traditional teaching styles. The set of questions provides a format for users to make numerous simple selections and obtain very quick feedback on the outcome of these decisions. The speed with which the user can acquire information and the breadth of topics that can be covered in this format allows for a much more pleasurable and effective learning experience than the user commonly encounters.

Coupled with the social network component described earlier, users will have an intrinsic motivator to seek security related information, and to modify their behavior so that they practice better security than other people. The presentation of feedback on performance, coupled with accurate educational materials and social comparison provide a strong, effective tool for increasing awareness and creating behavioral change.

### III. Examples of Implementation

The system and method as described can be used simply as an educational tool, or as an introduction or advertisement for security-related product. As one example, the first question may be presented in a “pop-up” on a web browser. If a user responds to the question, further display is generated to illustrate the security meter or otherwise provide graphic, text, or video information pertaining to the response. When the questionnaire concludes, the analysis can include an introduction to a software package or another product for enhancing the user's computer security.

In one embodiment, the tool may be employed by, for example, a financial institution with an online banking system, to educate the bank's account holders about security threats and how to improve security-related behaviors. As responses from account holders populate the tool's database with information, the tool also can provide useful poll information for assessing an institution's overall security risks. As another exemplary implementation, the tool may be provided to employees as part of a corporation's initiative to improve computer security. In a further embodiment, if the tool is configured for use with identified individuals, it can be especially adapted to incorporate information already known or that otherwise can be determined about a user's behavior to provide more detailed threat assessments and recommendations.

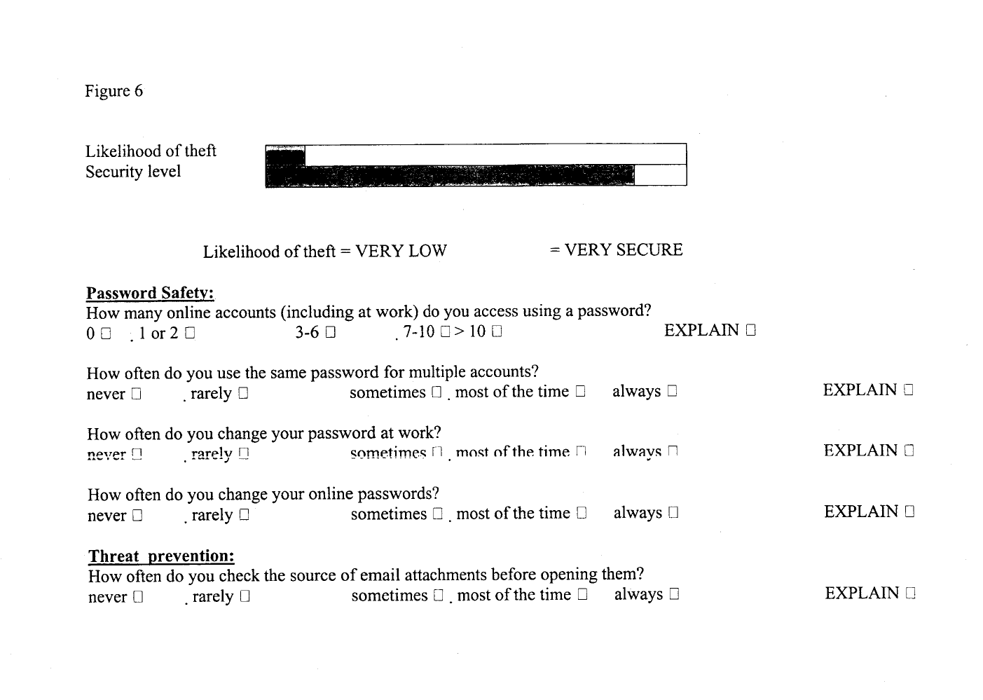

FIG. 6 is an exemplary screen shot of how questions can be presented to a user during the course of the described method. As can be seen, each question is followed by a set of choices. For example, in this screen shot, two topics are included, password safety and threat prevention. In the “password safety” section, the first question asked is: “How many online accounts (including at work) do you access using a password?” For this question, should the user respond that he accesses many online accounts, the overall likelihood of theft on the display may show an increase. That is because, statistically, users who maintain a large number of online accounts tend to have a greater likelihood of intrusion. The next question that is asked is “How often do you use the same password for multiple accounts?” If the user indicates that he never uses the same password for multiple accounts, this will lower the likelihood of theft, reversing course from the display after the response to the first question. As each question is answered, the “theft-meter” and “security-meter” change dynamically, providing instant feedback to encourage the user to continue with the questionnaire.

While in this screen shot several questions are simultaneously presented, it is also conceived that in alternative embodiments, only a single question will be presented at a time, with each response generating a display as part of the analysis. The display might include a text message, a graphic, or a short video clip.

The user could be shown a grid of own versus other behaviors that allows the user to compare his or her security awareness and practices with the people who share the computer resources (computers, routers, etc) with the user. This could help to raise the awareness of how the behavior of other people in the user's home or work environment can have adverse security consequences for the user. This leads to a social facilitation effect on security behavior and awareness as these user's may, for self protection, be more motivated to insist that their family and co-workers become more security savvy.

Alternatively, the user could be permitted to critique the assessment given by the tool and ask the community at large, through a connected social security network, to offer comments on a particular security opinion. Sites that have sought mass contributions like Wikipedia, have demonstrated that mass contribution can lead to a rapid development, refinement and accumulation of expert knowledge. This refinement could eventually be allowed to enhance the analytical equations used to give the quantified feedback to users by modifying the weighting parameters.

### IV. Conclusion

In general, the detailed description of embodiments is not intended to be exhaustive or to limit the invention to the precise form disclosed above. While specific embodiments and examples are described above for illustrative purposes, various equivalent modifications are possible within the scope of the disclosure, as those skilled in the relevant art will recognize. For example, while processes are presented in a given order, alternative embodiments may perform routines having steps in a different order, and some processes may be deleted, moved, added, subdivided, combined, and/or modified. Each of these processes may be implemented in a variety of different ways. Also, while processes are at times shown as being performed in series, these processes may instead be performed in parallel, or may be performed at different times.

The teachings provided herein can be applied to other systems, not necessarily the system described herein. The elements and acts of the various embodiments described herein can be combined to provide further embodiments.

Any patents, applications and other references, including any that may be listed in accompanying filing papers, are incorporated herein by reference. Aspects can be modified, if necessary, to employ the systems, functions, and concepts of the various references described above to provide yet further embodiments.

These and other changes can be made in light of the above Detailed Description. While the above description details certain embodiments and describes the best mode contemplated, no matter how detailed the above appears in text, the disclosure can be practiced in many ways. Details may vary considerably in its implementation details, while still being encompassed by the disclosure herein. As noted above, particular terminology used when describing certain features or aspects should not be taken to imply that the terminology is being redefined herein to be restricted to any specific characteristics, features, or aspects with which that terminology is associated. In general, the terms used in the following claims should not be construed to limit the import of the disclosure to the specific embodiments, unless the above Detailed Description section explicitly defines such terms. Accordingly, the actual scope of the disclosure encompasses not only the disclosed embodiments, but also all equivalent ways of practicing or implementing the above-described system and method.

I claim:

1. A method for assessing security risks attributed to a computer user's behavior, comprising:
presenting on a computer a series of questions to a user concerning behaviors that may affect a risk to the user's security;
receiving input on the computer from the user responding to the questions;
as responses are received to the questions, dynamically assessing changes to the user's security level as a result of additional information provided by the response; and
displaying a visual indication of the user's security level.

2. The method of claim 1, wherein the user's security level is assessed using a series of weighted decision algorithms that quantify a risk or benefit associated with user behaviors indicated by the user in response to questions.

3. The method of claim 1, wherein at least a first question is presented to the user via a pop-up on a web browser.

4. The method of claim 1, wherein a user is prompted to respond to the questions with a set of choices for each question.

5. The method of claim 1, wherein the visual indication of the user's security level is displayed graphically as a value between a minimum number and a maximum number within a scale.

6. The method of claim 1, wherein the visual indication of the user's security level is displayed as a comparative value that compares the user's behaviors with those of other computer users who responded to the questions.

7. A method for promoting software for enhancing a computer user's security, comprising:
presenting via a web browser on a computer a series of questions to a user concerning behaviors that may affect a risk to the user's security;
receiving input on the computer from the user responding to the questions;
presenting on a computer display an analysis of the likelihood of theft or a threat to the user's security as discerned from the input from the user; and
providing an advertisement for purchasing security-related software.

8. The method of claim 7, wherein at least a first question is presented to the user via a pop-up on a web browser.

9. The method of claim 7, wherein the display compares the user's behaviors with those of other computer users who responded to the questions.

10. The method of claim 7, wherein the computer display dynamically updates the analysis of the likelihood of theft or a threat to the user's security as each user response is received.

11. The method of claim 7, wherein the questions presented to the user are retrieved from a queue, and certain follow-up questions in the queue are skipped based upon the user's ongoing responses.

12. The method of claim 7, wherein the questions presented to the user concern issues commonly associated with computer security, including at least one of password sharing, token misplacement, email attachment protocols and frequency of calling a helpdesk for resets.

13. The method of claim 7, further comprising:
prompting the user to critique the analysis of the likelihood of theft or a threat to the user's security as discerned from the input received from the user.

14. A system for assessing security risks attributed to a computer user's behavior, comprising:
a question generator for presenting on a computer a series of questions to a user concerning behaviors that may affect a risk to the user's security;
a rules database for dynamically assessing changes to an assessment of the user's security level as a result of information provided in responses to the questions; and
a display generator for displaying a visual assessment of the user's security level.

15. The system of claim 14, wherein the display generator provides a visual indication of the user's security level displayed graphically as a value between a minimum number and a maximum number within a scale.

16. The system of claim 14, wherein the display generator provides a visual indication of the user's security level displayed as a comparative value that compares the user's behaviors with those of other computer users who responded to the questions.

17. The system of claim 14, further comprising a question database that stores a plurality of questions concerning issues commonly associated with computer security, including at least one of password sharing, token misplacement, email attachment protocols and frequency of calling a helpdesk for resets.

18. The system of claim 17, wherein the rules database assesses the user's security level using a series of weighted decision algorithms that quantify a risk or benefit associated with user behaviors indicated by the user in response to questions.

19. The system of claim 18, wherein the rules database determines whether additional questions from the question database are to be asked before performing a final risk analysis to be presented to the user.

20. The system of claim 14, wherein the display generator updates a display dynamically as a user edits responses to questions to thereby enable a user to visualize an effect that a variety of potential behaviors each has on security.
